(19) United States
(12) Patent Application Publication
(10) Pub. No.: US 2006/0092291 A1
(43) Pub. Date: May 4, 2006

(54) Digital imaging system

(76) Inventor: Jeffrey C. Bodie, Portland, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 10/977,534

(22) Filed: Oct. 28, 2004

(51) Int. Cl. H04N 5/76

(52) U.S. Cl. 348/231.99

(57) ABSTRACT

A digital imaging system includes facilities to capture an image and a related audio annotation, convert the audio annotation to text by voice recognition, and associate and edit the related image, audio annotation, and image caption.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to digital imaging systems and, more particularly, to a digital imaging device and system enabling text captioning of an image through conversion of an oral annotation to the image.

As the popularity of digital photography has increased, digital imaging systems have been incorporated into a wide variety of consumer electronic devices including cameras, portable computers, handheld computers, personal digital assistants (PDAs), and wireless telephones. At the same time, digital imaging systems have become increasingly sophisticated. By way examples, a digital camera may automatically balance the lighting between darker and lighter areas of a photograph to enhance the visible detail in shadowed areas or may search captured images for evidence of “red eye,” a common flash photography problem, and replace the red pixels of a captured image with pixels of a more natural color. Digital cameras may also permit previewing adjacent shots so that precisely aligned images can be “digitally stitched” together to form a photographic panorama.

Certain digital cameras also permit a user to record an audible caption or annotation in conjunction with an image. Bertis, U.S. Pat. No. 6,721,001, discloses a digital camera that records sound, which can include speech, in conjunction with a captured image. In addition, when the camera is returned to a cradle or otherwise connected to an external power source, the power connection is detected and voice recognition technology is enabled to convert the voice content of the recorded annotation to a text data file which is stored in the camera's memory. A separate digital signal processor (DSP) or the camera's microprocessor, executing voice recognition routines, performs voice recognition and text conversion. The image and text data are stored in the camera's memory and, if a data cable is connected, the camera's microprocessor transfers the stored image and the text data to an attached device, such as a personal computer.

The adaptation of digital imaging systems to devices that include sophisticated data and voice communication facilities permits a user to capture an image and transmit it to a remote consumer. However, once the image has been transmitted to a remote location the user typically no longer has access to it and can no longer edit the image or any related data. While some digital imaging systems permit capturing an image and a related audio annotation and converting the annotation to text, an imaging system with additional editing and organizing capabilities is desirable to permit the user to further refine the image and related audio and textual information before the data is transmitted to a consumer. It is desired, therefore, to provide an easily used digital imaging system and device that will permit a user to capture, edit, store, and transmit data comprising a “ready for consumption” visual, audio, and textual presentation.

### BRIEF DESCRIPTION OF THE DRAWINGS

FIG. 1 is a front view of an exemplary data processing device and system including a digital imaging system.

FIG. 1B is a rear view of the exemplary data processing device of FIG. 1A.

FIG. 2 is a block diagram of an exemplary data processing system including digital imaging system.

FIG. 3 is a flow diagram of a digital imaging method for a data processing system.

FIG. 4 is an exemplary display illustrating a menu of image caption editing options.

FIG. 5 is an exemplary display illustrating a text box for locating a caption for an image.

FIG. 6 is exemplary display illustrating a menu of audio editing options.

FIG. 7 is a schematic illustration of tables of a database for organizing digital images and associated audio annotations and captions.

### DETAILED DESCRIPTION OF THE INVENTION

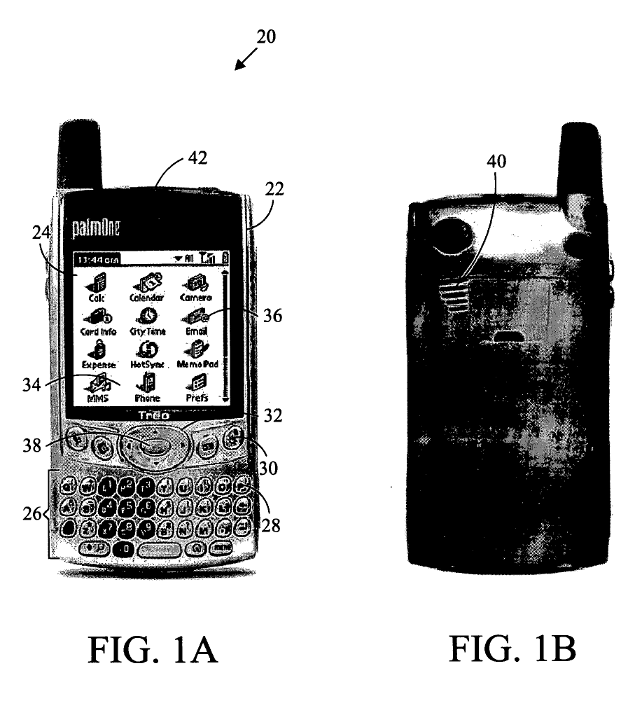

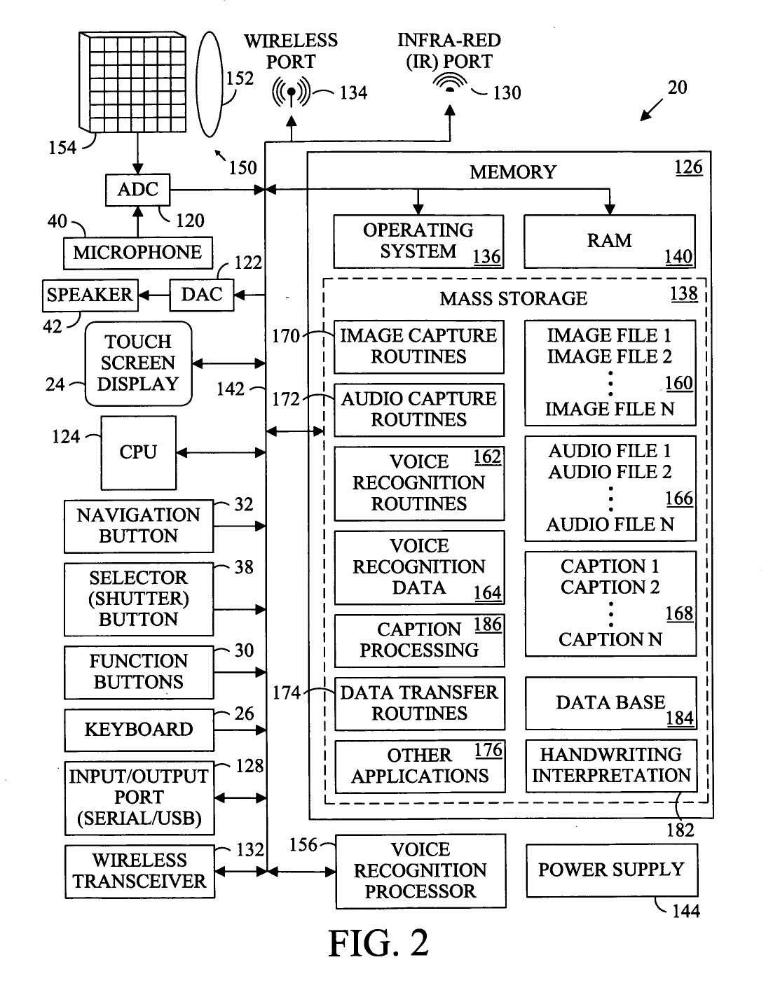

Referring in detail to the drawings where similar parts of the invention are identified by like reference numerals, and, more particularly to FIGS. 1A, 1B, and 2, electronic devices commonly incorporating digital imaging systems include handheld and portable personal computers, personal digital assistants (PDAs), wireless telephones, and digital cameras. While the components incorporated in and the gambit of functions performed by this group of exemplary devices may be disparate, digital imaging substantially comprises data processing and these devices or systems, including their components and software, are referred to herein as data processing devices or systems and, more specifically, digital imaging devices or systems.

A data processing system 20 providing a platform for the digital imaging system is typically incorporated in a handheld, portable device. The data processing system 20 is contained in a case 22 and includes a user interface, a power supply, a communications system and a data processing apparatus. The user interface commonly includes a display 24 for visually presenting output to the user. Many mobile data processing devices include a liquid crystal display (LCD) in which portions of a layer of dichromatic liquid crystals can be selectively, electro-magnetically switched to block or transmit polarized light. Another type of display comprises organic light emitting diodes (OLED) in which cells comprising a stack of organic layers are sandwiched between a transparent anode and a metallic cathode. When a voltage is applied to the anode and cathode of a cell, injected positive and negative charges recombine in an emissive layer to produce light through electro-luminescence. OLED displays are thinner, lighter, faster, cheaper, and require less power than LCD displays. Another emerging display technology for mobile data processing devices is the polymer light emission diode (PLED). PLED displays are created by sandwiching a polymer between two electrodes. The polymer emits light when exposed to a voltage applied to the electrodes. PLEDs enable thin, full-spectrum color displays that are relatively inexpensive compared to other display technologies, such as LCD or OLED, and which require little power to produce a substantial amount of light. The output of a digital imaging system is typically presentable on the display 24 of the data processing device 20 both before and after an image is captured permitting elimination of the traditional viewfinder for previewing images and enabling review of captured.

The user interface of the exemplary data processing system 20 also includes one or more user input devices. For example, the exemplary data processing system 20 includes a keyboard 26 (indicated by a bracket) (or external keyboard) comprising a plurality of user operable keys 28 for inputting text and performing other data processing activities. In addition, the user interface of the exemplary data processing system 20 includes a plurality of function keys 30. The function keys 30 may facilitate selecting and operating certain features or applications installed on the data processing system, such as a wireless telephone or electronic messaging. The function keys 30 may also be programmable to perform different functions during the operation of the different applications installed on the device. For example, when operation of a digital imaging system installed on the data processing system 20 is invoked certain function keys may become operable to control exposure, white balance, or other imaging related functions and activities.

The user interface of the exemplary data processing system 20 also includes a navigation button 32 that facilitates movement of a displayed pointer 34 for tasks such as scrolling through displayed icons 36, menus, lists, and text. In other devices the functions of the navigation button may be performed by a mouse, joy stick, stylus, or touch pad. The navigation button 32 includes a selector button 38 permitting displayed objects and text to be selected or activated in a manner analogous to the operation of a mouse button.

Further, the display 24 of the exemplary data processing device comprises a touch screen permitting the user to make inputs to the data processing system by touching the display with a stylus or other tactile device. The user can typically select applications and input commands to the data processing system by touching the screen at points designated by displayed menu entries and icons. The exemplary data processing system also includes a handwriting recognition application 182 that converts characters drawn on the touch screen display 24 with a tactile device or stylus to letters or numbers.

The exemplary data processing system 20 also includes a microphone 40. The microphone 40 is an audio transducer that converts the pressure fluctuations comprising sound, which may include speech, to an analog signal which is converted to digital data by an analog-to-digital converter (ADC) 120. The microphone may be built into the data processing device, as illustrated, or may be separate from the case 20 and connected to the data processing system 20 by a wire or by a wireless communication link. Audio output is provided by a speaker 42. Digital data is converted to an analog signal by a digital-to-analog converter (DAC) 122 and the speaker 42 converts the analog signal to sound. The microphone 40 and speaker 42 provide audio input and output, respectively, when using the wireless telephone and digital imaging systems of the exemplary data processing system and, in conjunction with voice recognition can enable verbal commands of a user to control the operation of the data processing device and the installed applications.

The data processing functions of the exemplary data processing 20 are performed by a central processing unit (CPU) 124 which is typically a microprocessor. A user can input data and commands to the CPU 124 with the various input devices of the user interface, including the selector button 32, keyboard 26, function buttons 30, and touch screen display 24. The CPU 124 fetches data and instructions from a memory 126 or the user interface, processes the data according to the instructions, and stores or transmits the result. The digital output of the CPU 124 may be used to operate an output device. For example, the digital output may be converted to analog signals by the DAC 122 to enable audio output by the speaker 42. On the other hand, the output of the CPU 124 may be transmitted to another data processing device. By way of examples, data may be transmitted to a remote data processing device, such as a personal computer or modem, via a cable connected to an input/output port 128, infra-red light signaling through infra-red port 130, or radio frequency signaling by a wireless transceiver 132 communicatively connected to a wireless port 134.

Instructions and data used by the CPU 124 are stored in the memory 126. Typically, the operating system 136, the basic operating instructions used by the CPU 124, is stored in a nonvolatile memory, such as read only memory (ROM) or flash memory. Application programs and data used by the CPU are typically stored in a mass storage portion 138 of the memory 126. The mass storage 138 may be built-in to the data processing system 20 and may comprise static random access memory (SRAM), flash memory, or a hard drive. On the other hand, the mass storage 138 may be a form of removable, non-volatile memory, such as flash memory cards; disk storage, such as a floppy disk, compact disk (CD), digital versatile disk (DVD), USB flash drive, or another removable media device. The data storage may be on a network for network aware devices. The data and instructions are typically transferred from the mass storage portion 138 of the memory 126 to a random access memory (RAM) 140 portion and fetched from RAM by the CPU 124 for execution. However, in wireless phones, PDAs, and cameras the mass storage may function as RAM with the data and instructions fetched directly from and stored directly in the mass storage. Data and instructions are typically transferred to and from the CPU 124 over an internal bus 142.

The data processing system also includes a power supply 144, which typically includes a battery and regulating circuitry. The battery may be removable for recharging or replacement or the power supply may include recharging circuitry to permit the battery to be recharged in the device. Integrating the recharging circuitry typically permits the data processing system 20 to be powered by an external power source, such as utility supplied, AC power.

The digital imaging system of the data processing system 20 includes an imaging apparatus 150, which receives light comprising an image and outputs image data representing the image, an audio annotation apparatus, and application software that recognizes and converts the speech content of the audio annotation to text for an image caption that is associable with the image and the audio annotation. The imaging apparatus 150 typically includes a lens 152, which focuses the image onto an image sensor 154, typically a charge-coupled device (CCD) or a complementary metal oxide semiconductor (CMOS) device. The imaging apparatus 150 may also include other well-known components, such as viewfinder, shutter switch, etc., that, for simplicity, are not illustrated.

The image sensor 154 outputs analog signals representing the intensity of light for each of a plurality of picture elements or pixels making up the image. The analog signals output by the image sensor 154 are input to an analog-to-digital converter (ADC) 120 that converts the analog signals to digital image data. The digital image data is output by the ADC 120 to the CPU 124 which stores the digital image data in the memory 126. The CPU 124 stores image data for each captured image in a respective image file 160. The image data is typically compressed before storage to reduce the amount of memory necessary to store the image.

Voice recognition may be performed by the CPU 124 or a voice recognition processor 156. Typically the voice recognition processor 156 is a digital signal processor (DSP) that enables conversion of the voice content of audio data to text in real-time or near-real time. Real-time or near-real time conversion of the voice content of audio data is particularly useful when the digital imaging system is used to capture and annotate a series of images, but a dedicated voice recognition processor is significantly more expensive than using the CPU to perform voice recognition. Voice recognition is performed by executing voice recognition routines 162 in conjunction with voice recognition data 164 and audio data. The voice recognition routines 162 control the processes for recognizing the speech or voice content of a recorded audio data file 166, generate text for an image caption, and store the text in a caption file 168 which is associable with a corresponding image file 160. Typically, the voice recognition routines 162 are stored in nonvolatile memory, such as flash memory. The voice recognition data 164 includes data relating audio data and corresponding text and may include particular words or phrases recorded and translated by the user in anticipation of difficult translation or the capture of specialized speech related to a subject of interest to the user. The voice recognition data 164 is commonly stored in RAM 140 but may be stored in removable memory, so that the imaging system may be customized to recognize particular voices or languages.

In addition to the image 170 and audio 172 capture routines and the voice recognition routines 162, the exemplary data processing system 20, also includes data transfer routines 174 that control the processes used in transferring data to and from the data processing system. The data transfer routines 174 may comprise e-mail, networking, and wireless data transfer programs. In addition, the exemplary data processing system 20 includes several other applications 176, stored in the memory 138, including an organizer application comprising a calendar, address book, contacts list, “To Do” list, and a note pad.

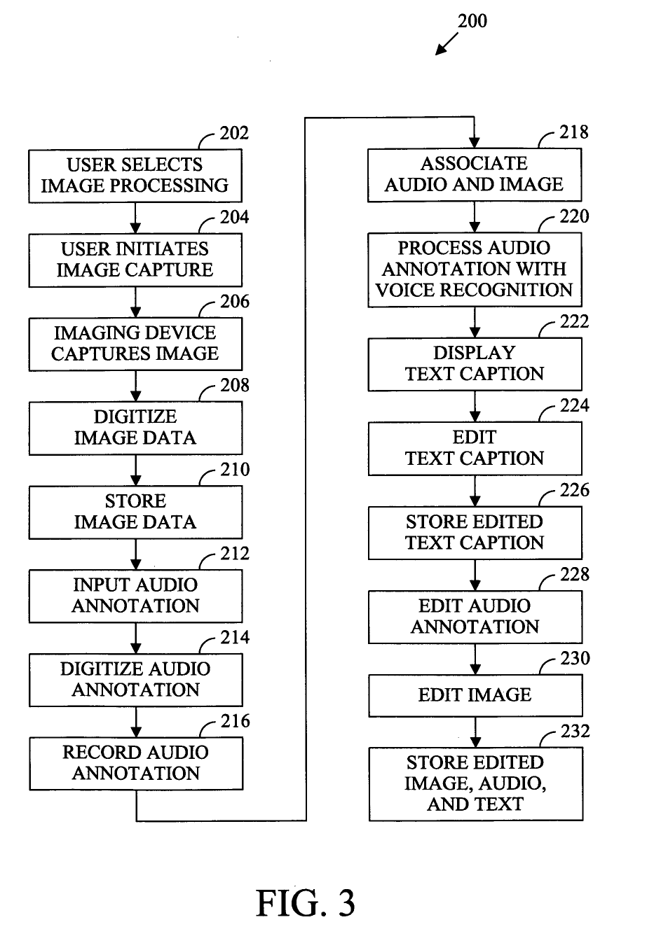

Referring to FIG. 3, the digital imaging process 200 is initiated when the user selects an icon 36 on the touch screen display 24 to activate the digital imaging system 202. Selecting the appropriate icon 36 causes the CPU 124 to enable the image 170 and audio capture 172 routines. Enabling the image capture routines 170 customizes certain user interface controls to operate as the user interface of the digital imaging system. For example, in the exemplary data processing system 20, the function of the selector button 38 is customized to operate as a shutter button when the digital imaging system is invoked and references herein to the shutter button are intended to refer to the selector button of the data processing system when operating as a digital imaging system and device. In addition, activating the digital imaging system causes the CPU 124 to display one or more menus on the touch screen to enable the user to select among several optional operating modes for the digital imaging system.

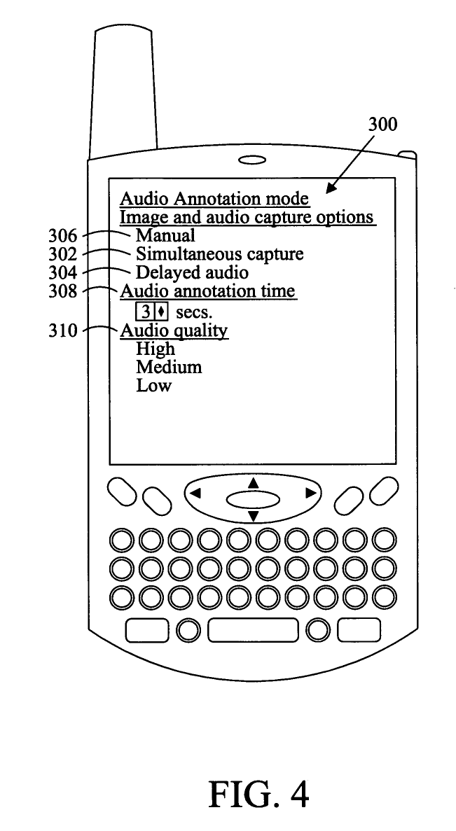

Referring to FIG. 4, for example, the user may elect to record the audio annotation at the same time as the image is being captured 302. Simultaneous capture of the image and a corresponding audio annotation may make it easier to capture the user's expectations and intentions for each image of a series than attempting to develop a caption for each of the images at some time after capture of the series of images. If this mode is selected, the CPU 124 will enable the microphone 40 and execute the audio capture routines when the shutter button 38 is depressed to capture the image. On the other hand, simultaneous capture of images and audio increases the quantity of data that the CPU 124 must read and store before the next image can be captured. This may unacceptably delay image capture when taking photos of rapidly changing action. The user may also elect to delay the audio capture until the image capture is complete 304. In this mode, the CPU 124 will alert the user when the image capture is complete by generating a tone with the speaker 42 and then will enable the microphone to capture the audio annotation. The audio capture proceeds until completed or until interrupted by actuation of the shutter button 38 to capture a subsequent image. In the manual mode 306, the microphone 40 is enabled to capture an audio annotation when one of the function buttons 30 is depressed and the corresponding captured image is displayed on the touch screen display 24. Capturing an audio annotation contemporaneous with or immediately following capture of an image when one of the automatic modes is selected or while an image is displayed on the touch screen display 24 will cause the CPU 124 to associate the resulting audio data file 166 with the image file 160 for the captured or displayed image, respectively.

In addition to selecting an audio capture mode, the menu of audio annotation options 300 also permits the user to select the duration 308 and quality level 310 of the stored annotation to limit the size of stored audio files 166. The user can specify a time interval over which an audio annotation will be recorded to limit the quantity of audio data to be included in the audio file 166 and, following voice recognition, the quantity of text to be included in the caption file 308. In addition, the user may select a quality level for the audio annotation causing the CPU 124 to increase or decrease the data compression ratio when storing the audio data. Increasing the compression ratio reduces the size of the audio file 166 but can distort the audio when it is decompressed for utterance over a speaker 42 or for another use.

Image capture 204 is initiated by the digital imaging system when the user actuates the shutter button 38 of the exemplary data processing device and system 20. Actuation of the shutter button 38 may operate a mechanical shutter in a manner similar to a film camera, but many digital imaging systems do not include a mechanical shutter and actuation of the “shutter” button causes the CPU 124 to execute the image capture routines 120 and read the analog signals output by the imaging sensor 206. The analog signals are converted to digital image data 208 by the ADC 120 and the CPU 124 stores the digital image data 210 in a first image file 160 in the memory 126. The image data may be compressed by the image capture routines before storage.

When audio annotation is initiated, according to the selected operating mode, the microphone 40 is enabled to sense impinging sound 212. The analog signals output by the microphone 40 are digitized 214 by the ADC 120 and the CPU 124 executes the audio annotation capture routines 172 to record, compress, and store the audio annotation 216 in an audio file 166 in the memory 126. As determined by the selected operating mode, the audio file 166 is associated with an image file 160 that corresponds to an image that is displayed on the touch screen display 24, or was captured contemporaneously with or immediately prior to the audio annotation capture 218. When the image is viewed, the system may present the text at the same time before moving to the next image.

The CPU 124 also enables the voice recognition process 220. If the data processing device includes a voice recognition processor 156, voice recognition can proceed in real time or near real time. On the other hand, if the CPU 124 performs voice recognition, the process is typically interruptible in the event that the user initiates capture of another image or audio annotation. The CPU 124 or the voice recognition processor 156 fetches audio data from audio data file 166 and translates the audio annotation data to text using the voice recognition data 164 and routines 162. When the voice recognition process is completed, the completion is signaled to the CPU 124 which stores the recognized text in a caption file 168 in the memory 126. The caption file 168 is associated with the corresponding audio 166 and image 160 data files. The audio annotation captured with the microphone 40 may not include speech content causing voice recognition to fail but the audio file and its association with a corresponding image file is retained.

The data processing system 20 includes a number of mechanisms; including a transceiver for a wireless telephone 132 and an input/output port 128, for transferring data, including the digital image, audio, and text data to remote consumers. For example, a real estate agent may desire to send a digital photograph of a kitchen with a text annotation indicating the property's address and an audio description of the appliances to a potential purchaser located in another city. Since the sender typically does not have access to the data after it is transferred, the data is typically presented to the consumer in the condition in which it was received at the remote location. The data processing system and included digital imaging system 20 permit extensive image, audio, and caption editing to enable the user to prepare a “finished” image, audio annotation, and caption for presentation to a consumer of the information.

When voice recognition has been completed 220, the text of the image caption included in the caption file 168 may be displayed on the touch screen display 222. The caption processing routines 180 stored in the memory 126 include text processing routines that permit the user to edit the text of an image caption 224. The text processing routines permit the user to delete portions or all of the caption and input new text from the keyboard 26 or, through use of the handwriting interpretation application 182, the touch screen display 24 to correct errors in the voice recognition or to otherwise edit or replace the text of the caption stored in the caption file 168 and store the edited text in the caption file 226. Also, the system may edit by audio interpretation, revise parts by audio interpretation, and revise associations.

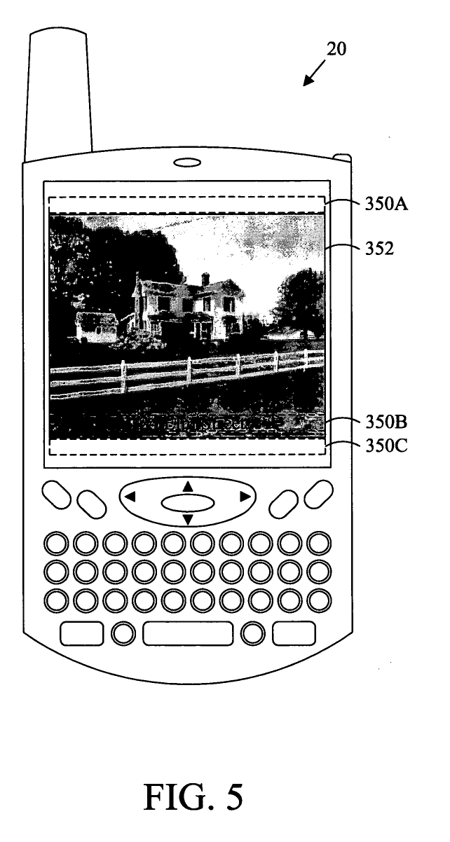

Referring to FIG. 5, the caption processing routines 180 also permit the user to display an image on the touch screen display 24 and superimpose on the image a movable text box 350. The text box 350 is a frame or container for the text contained in the associated caption file 168. Through the user interface, the user can graphically move the text box 350 to position and orient the text of the image caption, as illustrated by the alternate positions 350A, 350B, 350C, with respect to the image pixels as mapped in the image file 160. The caption processing routines 180 also include an image segmentation routine that causes the CPU 124 to search the pixels of an image for a plurality of neighboring pixels of substantially the same value and to position the caption in this visually flat region of the image. The caption processing routines 180 also cause the CPU 124 to scale the text of the caption to fill the transparent text box 350 permitting the user to alter the size of the displayed image caption by altering the size of the text box. The CPU 124 also stores a reference to the user selected size, position, and orientation of the caption in the caption file 168 so that the caption can be correctly displayed by the data processing device 24 and transmitted with the image for correct display by a remote consumer. To enable overlaying the caption on the image for displaying or printing, the caption processing routines 180 also enable conversion of the text in the caption file 168 to a dot matrix or raster graphics image having pixels that can be substituted for pixels of the image. The substitution of caption pixels for image pixels can be performed by the CPU 124 at the time the image is displayed or printed permitting the display of the caption to be toggled on and off or the substitution can be made permanent by saving the substituted pixels to the image file 160 to permanently substitute the caption pixels for pixels of the image.

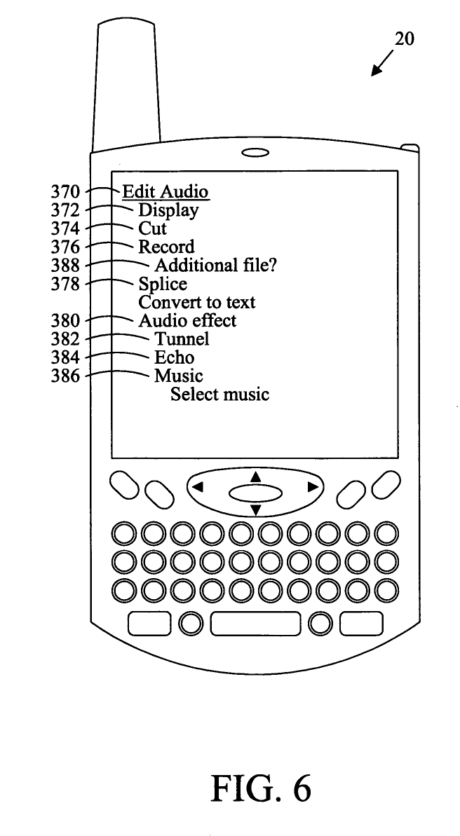

The audio capture routines 172 of the data processing system 20 also include editing routines permitting the user to edit the audio data file 228. Referring to FIG. 6, a menu of audio editing options 370 can displayed on the touch screen display. By selecting an appropriate option, the user can invoke the audio editing routines to display a visual representation of the spectrum of the audio data 372, delete a portion of the audio data 374, record a new audio annotation or a new portion of the annotation in the audio data file 376, splice a new portion of the audio annotation to the audio data in the audio file 378, or apply audio effects to an audio annotation 380. By way of examples, a “tunnel” effect 382, an echo 384, or background music 386 may be added to the audio data included in an audio file. In addition, the audio capture routines 172 permit the user to record a second audio annotation 322 related to an image; relate the second audio annotation to the desired image, and store the second audio annotation in an audio file 166 that is associated with a corresponding image file 160. Following editing of the audio annotation 228, the voice recognition routines may be executed to the convert the edited annotation to text. In addition, the data processing system may include image editing routines permitting the user to edit the image file, for example brighten dark areas of the image, 230. Following editing of the image, audio annotation, and caption files, the files and their associations are stored 232 for simultaneous presentation to the user of the data processing system or for transmission to a remote data processing system for simultaneous presentation to a remote consumer.

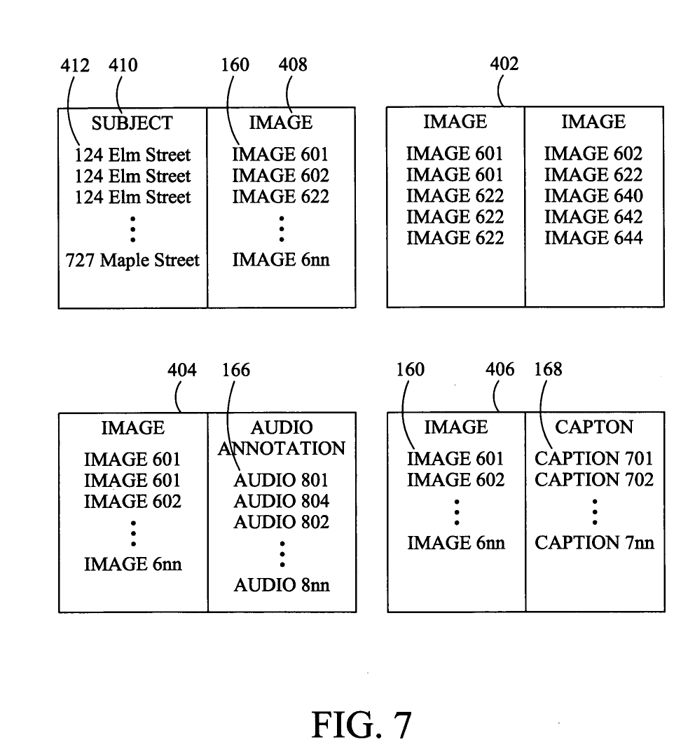

Referring to FIG. 7, the image data and audio data and caption data related to a captured image are stored in a plurality of, respectively, image 160, audio 166, and caption 168 files in the memory 126. The associations of the image files 160, caption files 166, and audio annotation files 168 are captured in a plurality of tables 404, 406, of a relational database 184. For example, as illustrated, the image 601 is associated with the caption 701 and two audio annotations 801 and 804. The database 184 also permits the user to associate a plurality of images and their related audio annotations and captions to each other or to a subject 410 or theme. For example, a group of images 601, 602, 622, and thereby their audio annotations and captions, related to a piece of real estate might be associated with the address of the property 412 or a group images captured at an event might be associated with the name of the event. On the other hand, the image data files of related images, such as several exterior views of a house, may be associated with each other. For example, table 402 illustrates an association of images 640, 642, 644 with image 622. The audio and caption files for the individual images remain associated with the corresponding images. The database can be queried to identify the associated images, captions, and audio annotations. For example, by selecting an image from a menu or thumbnail representation, the user can cause the image and its associated caption to be displayed and the associated audio annotation to be uttered by the speaker. Likewise, the user can command the data processing system 20 to search for specified text in the caption files 168 either by entering commands on the touch screen display 24 or with the keyboard 26 or by recording an audio command with the audio capture routines 172 which is converted to text for input to query routines for the database 184 with the voice recognition routines 162. The CPU 124 will search the caption files 168 for text matching the specified text and present the user with the image 160 and audio 166 files corresponding to the caption files 168 containing the specified text. For example, a real estate agent could identify a street and direct the data processing system 24 to identify all of the images and audio annotations that are associated with image captions containing that street name.

Voice recognition may also be used to in combination with the database 184 to edit the association of images, audio annotations, and captions. The user of the digital imaging system can modify the association of an image, audio annotation, and image caption by manipulating a menu displayed on the display 24 or by uttering words that are recognized as commands by the data processing system 20. For example, a caption specifying the address of a piece of property may be associated with a plurality of images of the property, an audio annotation may be specified as being a description of the picture associated with the annotation, the name of the place depicted, the time the picture was taken, the names of persons depicted, etc. The user of the data processing system 20 may enter information specifying the name, address, e-mail address, telephone number, etc. of a recipient for each image or a group of pictures and the appropriate associated captions and audio annotations.

The digital imaging system 20 enhances communication by providing a sophisticated environment for capturing, presenting, and transmitting images with associated contextual text and audio information.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

The invention claimed is:

1. A method of processing a digital image comprising the steps of:
(a) storing an image file comprising captured image data;
(b) storing an audio file comprising recorded audio data, said audio file being associable with said image file;
(c) converting said audio data of said audio file to text;
(d) storing said text in a caption file, said caption file being associable with said image file; and
(e) concurrently displaying data of said image file and text of said caption file on a display.

2. The method of processing a digital image of claim 1 wherein the step of concurrently displaying data of said image file and text of said caption file on a display comprises the steps of:
(a) converting said text of said caption file to a plurality of caption pixel data; and
(b) substituting a caption pixel datum for an image datum.

3. The method of processing a digital image of claim 1 further comprising the step of editing said text of said caption file.

4. The method of processing a digital image of claim 1 further comprising the step of concurrently uttering an audio signal representing said audio data of said audio file while said data of said image file and said text of said caption file are being displayed.

5. The method of processing a digital image of claim 1 further comprising the steps of:
(a) recording additional audio data;
(b) storing said additional audio data as a second audio file; said second audio file being associable with said image file; and
(c) uttering at least one audio signal representing at least one of said audio data of said audio file and said additional audio data of said second audio file while said data of said image file and said text of said caption file are being displayed.

6. A method of processing a digital image comprising the steps of:
(a) initiating capture of image data;
(b) initiating capture of audio data;
(c) storing said image data in an image file;
(d) storing said audio data in an audio file, said audio file being associable with said image file;
(e) converting said audio data to text;
(f) editing said text;
(g) storing said edited text in a caption file, said caption file being associated with said image file; and
(h) concurrently presenting said image data of said image file and said text of said caption file to a user of a data processing device.

7. The method of processing a digital image of claim 6 further comprising the step of concurrently uttering an audio signal representing said audio data of said audio file while said data of said image file and said text of said caption file are being displayed.

8. The method of processing a digital image of claim 6 further comprising the steps of:
(a) recording additional audio data;
(b) storing said additional audio data as a second audio file; said second audio file being associable with said image file; and
(c) uttering at least one audio signal representing at least one of said audio data of said audio file and said additional audio data of said second audio file while said data of said image file and said text of said caption file are being displayed.

9. The method of processing a digital image of claim 6 wherein the step of initiating capture of audio data is occasioned by said initiation of said capture of said image data.

10. The method of processing a digital image of claim 6 wherein the step of initiating capture of audio data is occasioned by and contemporaneous with said initiation of said capture of said image data.

11. The method of processing a digital image of claim 6 wherein the step of initiating capture of audio data is occasioned by completion of said capture of said image data.

12. The method of processing a digital image of claim 6 wherein the step of editing said text of said caption file comprises at least one of the steps of:
(a) deleting a datum representing text;
(b) adding a datum representing text;
(c) changing a display font for text;
(d) including text in a frame, said frame being movable with respect said image data; and
(e) including text in a frame, said text having a size, said size of said text being determined by a size of said frame.

13. The method of processing a digital image of claim 6 wherein the step of concurrently presenting said image data of said image file and said text of said caption file to a user of a data processing device comprises the steps of:
(a) converting said text to pixel data;
(b) substituting a pixel datum for an image datum; and
(c) presenting said image data including said pixel datum to said user.

14. The method of processing a digital image of claim 6 wherein the step of concurrently presenting said image data of said image file and said text of said caption file to a user of a data processing device comprises the steps of:
(a) converting said text to pixel data;
(b) substituting a pixel datum for an image datum;
(c) replacing image data in said image file with image data including said substituted pixel datum; and
(d) presenting said image data including said substituted pixel datum included in said image file to said user.

15. The method of processing a digital image of claim 6 further comprising the steps of:
(a) converting said text to pixel data;
(b) searching said image data for a plurality of neighboring, substantial identical image data;
(c) substituting a pixel datum for a datum of said neighboring, substantial identical image data; and
(d) presenting said image data including said substituted pixel datum to a consumer of said digital image.

16. A method of processing a digital image comprising the steps of:
(a) capturing image data representing an image;
(b) capturing audio data;
(c) storing said image data in an image file;
(d) storing said audio data in an audio file, an identity of said audio file being associated with an identity of an image file in a table;
(e) converting said audio data to text;
(f) projecting a container for said text on a display of said image, said container movable with respect to said image;
(g) storing a location of said container with respect to said image data;
(h) storing said text and said location in a caption file, an identity of said caption file being associated with said image file in a table; and
(i) transmitting said image file, said audio file and said caption file to a remote data processing device for presentation on said remote data processing device.

17. A digital imaging system comprising:
(a) an image sensor converting light impinging on said image sensor to an image signal;
(b) a first audio transducer converting sound to an audio signal;
(c) a display;
(d) a memory;
(e) a data processor;
(f) a routine stored in said memory, said routine including an instruction executable by said data processor to:
(i) convert said image signal to image data and said audio signal to audio data;
(ii) store said image data in an image file and said audio data in an audio file;
(iii) establish an association of said audio file with said image file;
(iv) convert said audio data to text;
(v) store said text in a caption file; and
(vi) concurrently present said image data and said text of said caption file on said display of said data processing device.

18. The digital imaging system of claim 17 further comprising:
(a) a second audio transducer; and
(b) another routine including an instruction executable by said data processor to convert said audio data to an audio signal, said audio signal causing said second transducer to utter a sound defined by said audio signal.

19. The digital imaging system of claim 17 further comprising an additional routine stored in said memory, said additional routine containing an instruction executable by said data processor to contemporaneously capture an audio signal output by said first audio transducer and an image signal output by said image sensor.

20. The digital imaging system of claim 17 further comprising an additional routine stored in said memory, said additional routine containing an instruction executable by said data processor to capture of an image signal output by said image sensor and to capture an audio signal output by said first audio transducer following storage of image data sufficient to describe an image.

21. The digital imaging system of claim 17 further comprising an additional routine stored in said memory, said additional routine containing an instruction executable by said data processor to capture an audio signal output by said first audio transducer following capture of an image signal output by said image sensor.

22. The digital imaging system of claim 17 further comprising an additional routine stored in said memory, said additional routine containing an instruction executable by said data processor in response to a command from a user to, at least one, of:
(a) delete a datum representing text from said caption file;
(b) adding a datum representing text to said caption file;
(c) change a displayed font for text; and
(d) insert text into a frame, said frame being movable and resizable with respect said image data and said text having a size determined by a size of said frame.

23. The digital imaging system of claim 17 further comprising an additional routine stored in said memory, said additional routine containing an instruction executable by said data processor to:
(a) convert said text to pixel data;
(b) substitute a pixel datum for an image datum; and
(c) display said image data including said pixel datum.

24. A digital imaging system comprising:
(a) an imaging apparatus converting light impinging on an image sensor to image data;
(b) a first audio transducer converting sound to an audio data;
(c) a second audio transducer converting audio data to sound;
(d) a display;
(e) a memory;
(f) a transceiver for sending and receiving data from said digital imaging system to a remote data processing system;
(g) a data processor;
(h) a routine stored in said memory, said routine including an instruction executable by said data processor to:
(i) convert said audio data to text;
(ii) store said image data in an image file, said audio data in an audio file and said text in a caption file;
(iii) establish a table expressing an association of said image file with said audio file and with said caption file, said table searchable by said data processor to identify said associated image, audio, and caption files;
(iv) enable a user of said digital imaging system to edit said text, including establish a relationship between a displayed position of said text and a displayed position of said image data;
(v) store said edited text including said relationship between said displayed position of said text and said displayed position of said image data; and
(vi) transmit said data of said image file, said audio file, and said caption file to a remote data processing device for concurrent presentation of said image data and said text of said caption file by said remote data processing device.
